(19) United States
(12) Patent Application Publication
(10) Pub. No.: US 2020/0363499 A1
(43) Pub. Date: Nov. 19, 2020

(54) RADAR SYSTEM HAVING AN ANALYSIS UNIT INTEGRATED INTO A RADAR SENSOR HEAD

(71) Applicant: Robert Bosch GmbH, Stuttgart (DE)

(72) Inventors: Marcel Mayer, Lonsee (DE); Michael Schoor, Stuttgart (DE)

(21) Appl. No.: 16/766,132

(22) PCT Filed: Nov. 8, 2018
(86) PCT No.: PCT/EP2018/080694

§ 371 Date: May 21, 2020

(30) Foreign Application Priority Data
Jan. 11, 2018 (DE) 10 2018 200 394.7

(51) Int. Cl. G01S 7/35; G01S 13/931

(52) U.S. Cl. CPC G01S 7/352; G01S 2007/356; G01S 13/931

(57) ABSTRACT

A radar system for a vehicle. The radar system includes at least one central control unit for transmitting data and for processing received data, at least one radar sensor head, which is set apart from the central control unit and has at least one radar sensor head, which is set apart from the at least one central control unit and has at least one transmitting antenna for generating and at least one receiving antenna for receiving radar waves, and having at least one data line between the at least one central control unit and the at least one radar sensor head, and the at least one radar sensor head has an analysis unit, connected downstream from an analog-to-digital converter and upstream from the at least one data line, for the at least partial processing of digital measuring data generated by the analog-to-digital converter.

### FIELD

The present invention relates to a radar system for a vehicle, which has a central control unit for transmitting data and for processing received data, at least one radar sensor head, which is set apart from the central control unit and has at least one transmitting antenna for generating and at least one receiving antenna for receiving radar waves, and it has at least one data line between the central control unit and the at least one radar sensor head.

### BACKGROUND INFORMATION

An ever increasing number of radar sensors is installed in vehicles that provide a high degree of driver assistance functions or automated driving functions. The greater number of radar sensors is used in an effort to achieve a higher performance of the automated or semi-automated driving functions in comparison with individual radar sensors. Current solutions in this area are radar sensors which carry out extensive data processing of the received radar waves within the sensor. Radar sensors are therefore able to supply data at an object or locating level for a further evaluation by the vehicle. This makes it possible to reduce the data quantity transmitted to the vehicle, but the respective radar sensors have to have more processing power and a larger memory.

Disadvantageous in this context is that the processing power and the memory size are relatively difficult to scale with regard to a greater performance. This is primarily due to the fact that, based on a defined demand on the capacity, the microcontroller technology is no longer sufficient for the required processing steps of the received radar waves. To increase the capacity, the required calculations and analyses must therefore be carried out inside the sensor within the framework of microprocessor technologies. This may have a disadvantageous effect on the price, size and on power losses of a radar sensor.

### SUMMARY

An object of the present invention is to provide a radar system for vehicles which is scalable in a cost-effective and flexible manner with regard to the number of used radar sensors and the capacity.

This object may be achieved by example embodiments in accordance with the present invention. Advantageous embodiments of the present invention are described herein.

According to one aspect of the present invention, a radar system is provided for a vehicle. An example radar system according to the present invention has at least one central control unit for transmitting data and for processing received data. In addition, the radar system has at least one radar sensor head, which is set apart from the central control unit and has at least one transmitting antenna for generating radar waves and at least one receiving antenna for receiving radar waves. For the transmission of data, the radar system has at least one data line between the at least one central control unit and the at least one radar sensor head. According to the present invention, the at least one radar sensor head has an analysis unit, which is connected downstream from an analog-to-digital converter and upstream from the at least one data line for the at least partial processing of digital measuring data generated by the analog-to-digital converter (16).

Current radar sensors are often configured as fast-chirp radar. This means that many fast FMCW (Frequency Modulated Continuous Wave) ramps are transmitted into a scanning region, which is also known as a chirp sequence or a rapid chirp method. After the received radar signals have been mixed, the baseband signals are filtered, digitized and generally conveyed to a 2D Fourier transform. Because a subsequent Doppler-FFT (Fast Fourier Transform) is able to take place only once the data or measuring signals of all ramps or frequencies have been processed, a large memory is required for buffering the received radar signals. In addition, due to the high latency requirement, a high processing power is necessary, which is why hardware accelerators are used as a rule.

Under the aspect that a plurality of radar sensors is employed in a vehicle, it is advantageous to concentrate the required computing power in at least one central control unit. The respective radar sensors may thus be developed as compact and cost-effective radar sensor heads without any significant power losses. This makes it possible to realize a more optimal price-performance ratio and a higher performance of the radar system as a whole.

In the example radar system according to the present invention, the at least one radar sensor head includes components for generating and transmitting radar waves as well as components for receiving and processing received radar waves. The processing of the received radar waves is kept to a minimum or is carried out at the lowest expense possible. In particular, the measuring data of the received radar waves are able to be digitized by the analog-to-digital converter and then be transmitted at a high bandwidth to the at least one central control unit. The further processing of the digitized measuring data from the at least one radar sensor head may subsequently be performed in the at least one central control unit.

This makes it possible to reduce the cost of the respective radar sensor heads because less processing power is required in the individual radar sensor heads. In addition, a power loss in the respective radar sensor heads may be lower as a result of the smaller number of processing steps. Although the computational effort becomes greater in the at least one central control unit, the computing power is scalable more easily or with less effort in comparison with the related expense. In an overall view of the radar system, the radar system according to the present invention is able to be expanded and scaled in a cost-effective and flexible manner in comparison with current solutions. In addition, due to the higher computing power of the at least one central control unit, more complex and more efficient algorithms are able to be used for processing the received radar waves.

With an increasing degree of high integration, it is additionally possible to integrate a first processing stage into a high-frequency component, e.g., what is termed a monolithic microwave integrated circuit (MMIC). This may preferably be an analysis unit for carrying out a Fourier analysis. For example, the analysis unit may perform a Range FFT of the digitized measuring data. Depending on the modulation method that is used, other Fourier transforms may be employed as well. This first processing stage is usually able to be integrated into the existing components of a radar sensor head in a cost-effective manner because the required space in the high frequency component is very small and the memory requirement is low. As a result, the used silicon area may normally remain unchanged during the production of corresponding high frequency components.

The example radar system according to the present invention is described here with reference to a chirp sequence radar by way of example, but it is also applicable to other types of radar and modulations. Alternative radar methods, for example, may be a slow FMCW radar without a subsequent Doppler FFT, a PN radar provided with an analysis unit as a correlator bank or an OFDM radar having an analysis unit for performing a spectral division.

According to one exemplary embodiment of the radar system in accordance with the present invention, the analysis unit connected upstream from the at least one data line is able to carry out a Fourier transform and/or an orthogonal frequency multiplex method and/or at least one correlator. The scanning values or received radar waves are thus not directly transmitted after the digitization but subjected to a first processing stage. The fast Fourier transform, for instance, may be a range FFT, which may be adapted to the individual application purpose. It is possible, for instance, that the fast Fourier transform is able to be carried out only up to the anti-aliasing filter limit.

The processing effort in the at least one central control unit is able to be reduced by the first processing stage. In addition, a data quantity to be transmitted via the at least one data line may be reduced.

According to another exemplary embodiment of the radar system according to the present invention, the radar waves received by the at least one receiving antenna of the at least one radar sensor head are able to be converted into digital measuring data with the aid of an analog-to-digital converter and be marked with at least one time datum. In this way, the received radar waves or measuring data are able to be converted into a digital format and thus be further processed in a less complicated fashion. In an advantageous manner, the measuring data converted into a digital format may be provided with a time stamp. For example, each recorded spectrum may receive its own time stamp.

According to a further exemplary embodiment of the radar system according to the present invention, the analysis unit is able to be used for buffering the generated digital measuring data. Preferably, the analysis unit may be provided to carry out a range FFT in the radar sensor head. Since this transform requires relatively little memory space, it is possible to produce the analysis unit on the basis of RFCMOS technology, for example, and to integrate it into an MMIC such as a high frequency component of the radar sensor head. Because not all range bins are required on account of the anti-aliasing filter, e.g., 90% to 45% of the bins, the resulting data quantity is able to be reduced and the FFT may simultaneously be utilized as a buffer for reducing peak data rates of the radar sensor head.

According to another exemplary embodiment of the radar sensor according to the present invention, the digital measuring data are transmittable to the central control unit via the at least one data line and able to be synchronized in the central control unit with the aid of the at least one time datum. Because of the first processing of the received measuring data in the radar sensor head, defined buffering of the arising data quantity takes place. The deviations between the at least one radar sensor head and the at least one central control unit that result therefrom are able to be compensated for based on the assigned time datum. The time datum may preferably be realized in the form of a time stamp or a plurality of time stamps. The time stamps are therefore usable for a time synchronization of the measuring data between the at least one radar sensor head of the at least one central control unit. This makes it possible to correctly classify, in terms of time, even measuring data that are transmitted to the at least one central control unit with a delay and to use the measuring data for further applications or calculations.

According to another exemplary embodiment of the radar system according to the present invention, the at least one time datum is able to be generated by a time and control device, which is situated in the at least one radar sensor head. The at least one radar sensor head may thus include an additional circuit, which is disposed in parallel with the analysis unit. The time and control device, for instance, is able to receive and implement control commands transmitted via the at least one data line and provide the digitized measuring data with precise time information. In addition, the time and control device is able to be used for a control of the at least one radar sensor head as well as for the monitoring control or a cycle control, for example. In order to allow for a time synchronization in the radar system, the time and control device, for example, has to add time stamps to the transmitted measuring data for each transmitted chirp or each transmitted cycle so that the at least one central control unit is able to utilize the transmitted measuring data in a useful manner.

According to a further exemplary embodiment of the radar system according to the present invention, the at least one transmitting antenna of the at least one radar sensor head has an oscillator for generating a carrier frequency. The oscillator is adjustable by the time and control device using the central control unit. By implementing the time and control device in the at least one radar sensor head, the components of the at least one radar sensor head are able to be influenced by the at least one central control unit. The oscillator or the oscillators of the at least one radar sensor head are thus able to be controlled or regulated, either directly or indirectly.

According to another exemplary embodiment of the radar system according to the present invention, oscillators of at least two radar sensor heads are able to be mutually synchronized by the central control unit. A plurality of radar sensor heads that are set apart from one another may be installed in a vehicle and be connected in a data-transmitting manner to a central control unit or a plurality of central control units. When multiple radar sensor heads are used, the respective oscillators of the transmitting antennas are able to be synchronized with one another because of the implemented time and control devices in the different radar sensor heads. The accuracy of the measuring results is therefore able to be increased. This makes it possible to optimize the driver assistance functions or the automated driving function of the vehicle. In addition, the number of used radar sensor heads is able to be increased as desired without negative effects on the performance.

According to an additional exemplary embodiment of the radar system in accordance with the present invention, the data transmitted via the at least one data line are transmittable at a higher data rate than a reference frequency of the at least one transmitting antenna of the at least one radar sensor head. To allow for an optimal operation of the time and control device for the control or regulation of the at least one radar sensor head, the transmission of the data via the at least one data line must be carried out with a higher time resolution than the radar operation. Further functions such as safety functions for monitoring frequency deviations of different oscillators are thereby able to be integrated into the radar system according to the present invention. The higher time resolution for the data transmission is technically easy to realize within the scope of an MMIC technology because the technology allows for frequencies of multiple Gigahertz. For instance, a time stamp is able to be transmitted at 1 GHz and with a time resolution of 1 ns without any problems. The internal reference frequency, for example, may be 50 MHz for a PLL reference of the at least one transmitting antenna, which means that the data rate according to the example must be higher than 50 Mbit/s.

According to an additional exemplary embodiment of the radar system in accordance with the present invention, the at least one central control unit has at least one processor for the processing of received data and at least one memory for the at least intermittent storing of data. As a result, the at least one central control unit is able to at least intermittently store the measuring data from at least one radar sensor head transmitted via the at least one data line and process, forward or output it according to a request of the respective application. If required, the at least one central control unit is able to be exchanged for a more powerful control unit. Since microprocessor technology is already being employed here, complex algorithms for processing the measuring data may be used and more precise calculation results be achieved as a result.

Preferred exemplary embodiments of the present invention are described in greater detail below based on a heavily simplified schematic figures.

### BRIEF DESCRIPTION OF THE DRAWINGS

FIG. 1 shows a schematic representation of a radar system according to a first specific embodiment of the present invention.

FIG. 2 shows a schematic representation of a radar system according to a second specific embodiment of the present invention.

Identical constructive elements in the figures have been provided with the same reference numerals.

### DETAILED DESCRIPTION OF EXAMPLE EMBODIMENTS

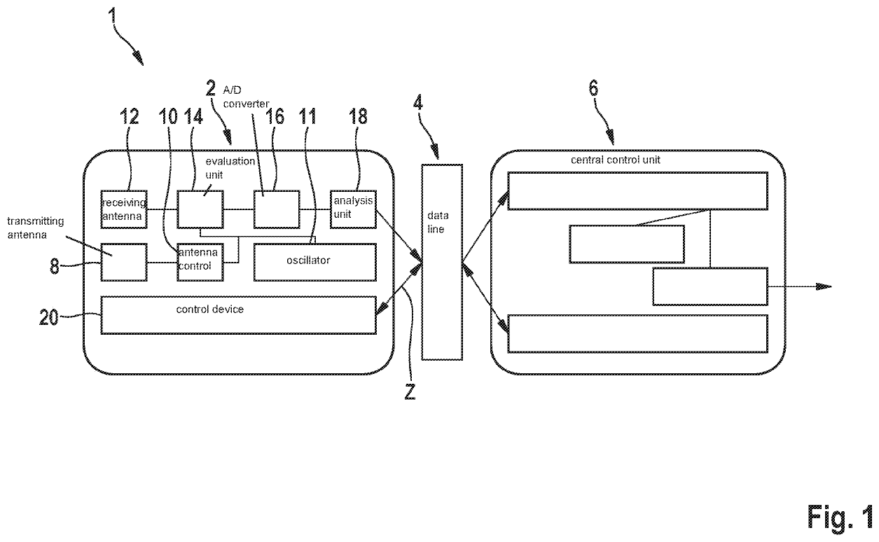

FIG. 1 shows a schematic illustration of a radar system 1 according to a first specific embodiment of the present invention. Radar system 1 is made up of a radar sensor head 2, which is coupled via a data line 4 with a central control unit 6.

Radar sensor head 2 has at least one transmitting antenna 8, which is operable via an antenna control 10. Antenna control 10 is connected to, among others, an oscillator 11 for the generation of a carrier frequency of the radar waves.

In addition, at least one receiving antenna 12 including a corresponding evaluation unit 14 for receiving radar waves is situated in radar sensor head 2. The received radar waves are able to be converted into digital measuring data by an analog-to-digital converter 16 and then be transformed by an analysis unit 18 in radar sensor head 2 in a first processing step.

The transformed digital measuring data are then able to be transmitted to central control unit 6 via a broadband data line 4. A time stamp Z is allocated to the transmitted digital measuring data by a time and control device 20 situated in radar sensor head 2 and also transmitted to central control unit 6.

Central control unit 6 is able to receive the transmitted digital measuring data and further process the data. Because of time stamps Z transmitted together with the measuring data, the measuring data are able to be precisely categorized in terms of time.

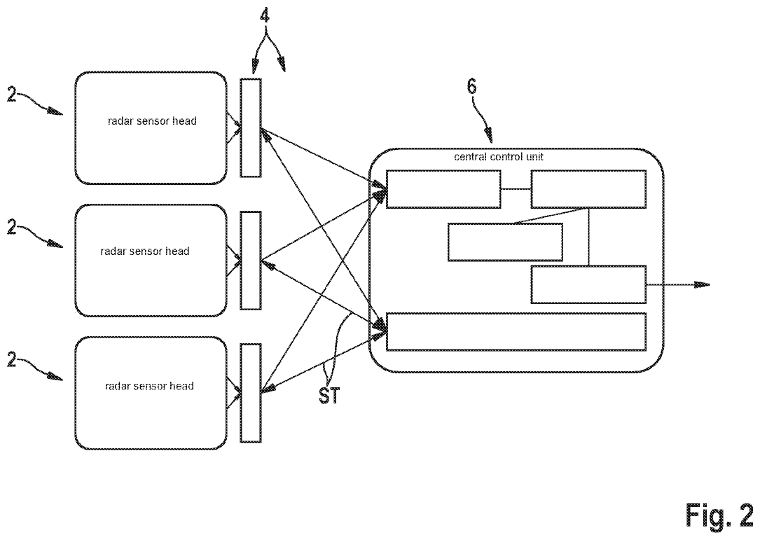

FIG. 2 shows a schematic representation of a radar system 1 according to a second specific embodiment of the present invention. In contrast to radar system 1 according to the first exemplary embodiment of the present invention, three radar sensor heads 2 are connected by way of corresponding data lines 4 to a central control unit 6 in this instance. Central control unit 6 outputs control commands ST to time and control devices 20 of the respective radar sensor heads 2 via data lines 4. This makes it possible to mutually adapt and synchronize the different radar sensor heads 2 and especially respective oscillators 11 in an optimal manner.

1-10 (canceled)

11. A radar system for a vehicle, comprising:
at least one central control unit configured to transmit data and to process received data;
at least one radar sensor head, which is set apart from the at least one central control unit, the at least one radar sensor head including at least one transmitting antenna for generating radar waves and at least one receiving antenna for receiving radar waves; and
at least one data line between the at least one central control unit and the at least one radar sensor head;
wherein the at least one radar sensor head includes an analysis unit which is connected downstream from an analog-to-digital converter and upstream from the at least one data line or at least partial processing of digital measuring data generated by the analog-to-digital converter.

12. The radar system as recited in claim 11, wherein the analysis unit connected upstream from the at least one data line is configured to carry out a Fourier transform and/or an orthogonal frequency multiplex method and/or at least one correlator.

13. The radar system as recited in claim 11, wherein the analog-to-digital converter is configured to convert radar waves received by the at least one receiving antenna of the at least one radar sensor head into digital measuring data, and the at least one radar head is configured to mark the digital measuring data with at least one time datum.

14. The radar system as recited in claim 13, wherein the analysis unit is configured to buffer the digital measuring data.

15. The radar system as recited in claim 13, wherein the digital measuring data are transmittable to the at least one central control unit via the at least one data line, and wherein the at least one central control unit is configured to synchronize the digital measuring data using the at least one time datum.

16. The radar system as recited in claim 13, wherein the at least one radar sensor head includes a time and control device, the time and control device being configured to generate the at least one time datum.

17. The radar system as recited in claim 16, wherein the at least one transmitting antenna of the at least one radar sensor head has an oscillator for generating a carrier frequency, and the oscillator is adjustable by the time and control device using the at least one central control unit.

18. The radar system as recited in claim 11, wherein the at least one central control unit is configured to mutually synchronize oscillators of at least two radar sensor heads.

19. The radar system as recited in claim 11, wherein radar system is configured to transmit data via the at least one data line at a higher data rate than a reference frequency of the at least one transmitting antenna of the at least one radar sensor head.

20. The radar system as recited in claim 11, wherein the at least one central control unit has at least one processor configured to process received data, and at least one memory for at least intermittent storage of data.
